(19) United States
(12) Patent Application Publication
(10) Pub. No.: US 2019/0215335 A1
(43) Pub. Date: Jul. 11, 2019

(54) METHOD AND SYSTEM FOR DELAYING MESSAGE DELIVERY TO USERS CATEGORIZED WITH LOW LEVEL OF AWARENESS TO SUSPICIUS MESSAGES

(71) Applicant: IRONSCALES LTD., Tel Aviv (IL)

(72) Inventor: Eyal BENISHTI, Atlanta, GA (US)

(21) Appl. No.: 16/299,197

(22) Filed: Mar. 12, 2019

Related U.S. Application Data
(63) Continuation-in-part of application No. 15/581,336, filed on Apr. 28, 2017.
Application No. 15/581,336 is a continuation-in-part of application No. PCT/IL2015/051055, filed on Oct. 28, 2015.

(30) Foreign Application Priority Data
Oct. 30, 2014 (IL) 235423

(51) Int. Cl. H04L 29/06

(52) U.S. Cl. CPC H04L 63/1441; H04L 63/1483

(57) ABSTRACT

The subject matter discloses a method and a system for receiving a message designated to a plurality of recipients and delivering the message only to one or more selected recipients. The selected recipients are classified as having high level of awareness to malicious messages. The system further monitors the behavior of the selected recipient with the message. The monitoring results in identifying status of the message. If the status of the message is identified as malicious the system performs mitigation action on the message for disabling the message. Otherwise the system delivers the message to the other recipients.

### FIELD OF THE INVENTION

The present disclosure relates to the field of Internet security. More particularly, the disclosure relates to securing messages over the internet.

### BACKGROUND OF THE INVENTION

As more users are connected to the Internet and conduct their daily activities electronically, their electronic communication means, such as e-mail accounts, mobile devices (e.g., via SMS, WhatsApp or other application for communicating messages) and the like, have become the target of malicious attempts to install malicious code/software, acquire sensitive information such as usernames, passwords, credit card details, etc. For example, phishing and spear-phishing attacks may target a specific organization, seeking unauthorized access to confidential data for financial gain, trade secrets or military information. One particularly dangerous type of phishing/spear-phishing directs users to perform an action, such as opening an e-mail attachment, e.g., opening an attachment to view an “important document” might in fact install malicious computer software (i.e., spyware, a virus, and/or other malware) on the user's computer, or following (e.g., using a cursor controlled device or touch screen) an embedded link to enter details at a fake website, e.g. the website of a financial institution, or a page which requires entering financial information, the look and feel of which are almost identical to the legitimate one. Attempts to deal with the growing number of reported phishing incidents include legislation, user training, public awareness, and technical security measures.

### SUMMARY OF THE INVENTION

The term message is used to indicate an electronic form of exchanging digital content from an author to one or more recipients. This term does not imply any particular messaging method, and the invention is applicable to all suitable methods of exchanging digital messages such as email, SMS, Instant Messaging (IM), Social Media, the WHATSAPP messages, Websites and the like.

The term polymorphic refers herein a plurality of messages (e.g. email messages) that are visually/textually/contextually unequal, although that essentially contain similar malicious contents, such as a link to a hazardous IP or a downloadable attachment containing a virus, or is luring the victim to response with data that might lead to an account being compromise for instance. The Similarity may be in the subject of the message or in the content of the body of the message.

The term awareness level refers herein to the awareness of a user for receiving a suspicious or a malicious message or to the trustworthiness of the user. The awareness level may represent the skills and/or abilities of the user to identify malicious attack attempts in an electronic messaging environment, for example the ability to identify possible phishing attacks.

The term disabling a message refers herein to disabling the access to links and attachments of the message (Preventing click on the links or attachment or downloading the links or the attachments). The term may also refer to warning the recipient or blocking the replies to this message.

The term quarantine refers herein to moving the message to a temporary folder away from the user sight or access.

Users with high awareness level for spotting and reporting suspicious messages may be extensively trained or may have natural skill to detect and flag fraudulent and malicious messages. The user with low level of awareness may be easy clickers. The awareness levels may include two or more different levels, such as the followings:
Easy Clicker—an employee that repeatedly fall victim to mock phishing attacks launched by the system;
New employee/Newbie;
Novice;
Intermediate;
Advanced;
Expert.

The term inbox refers herein to a receiving box for a messaging service. Examples for such messaging service are mail service the WHATSAPP service, any social network messaging service and the like.

According to some embodiment of the disclosed subject matter, the system assigns an awareness level to users of the system.

The awareness level for each user may be set automatically according to his success/failure rate to report targeted electronic messages based attacks in the past when they happened or manually by a system administrator or other authorized person, or a combination thereof. For example, the system administrator might apply a simulated attack program to determine the user awareness level. The awareness level might change over time based on the user performance in the simulated attack program and/or the day-to-day experience, or manually by a system administrator or other authorized person. A user with a high awareness level is typically a user security savvy user.

For example, if the user were reporting an email as suspicious and it turned out to be an actual targeted attack, based on other users reports or an expert report, the user awareness level will be leveled up. On the other hand, if a suspicious email was residing in the user mailbox and the user fails to report about it, and it finally turned out to be an actual malicious one or a simulated one as explained above, the user awareness level may remain the same or might be even reduced to a lower awareness level.

According to some embodiments the system delays email delivery to users having low level of awareness. The delay is for verifying that the email is not malicious and for delivering to such user only emails that are not detected by the system as malicious.

In some embodiments a message is first delivered to users with high awareness level and/or to external threat intelligence, while the delivery to users with lower level of awareness is delayed. If the user with high awareness level identifies the message as malicious or suspicious the message is not delivered to the other users. If the message is not identifies as malicious it is delivered to the less awarded users. In some embodiments the system delays the delivery of messages that are received from un-trusted senders or that include un-trusted link or attachment. In the latter case the link or the attachment is examined before the message is delivered to the user.

According to some embodiments the system delays the delivering of a message to users with a low level of awareness. According to some embodiments the delay is for a predefined timeout. During the timeout the system may receive a report of an incoming suspicious or malicious message. The report may be received from a user with high level of awareness. In response to the report the system applies similarity algorithm for detecting similarity between the incoming suspicious or malicious message and the delayed massage. The similarity algorithm generates a score of similarity. If the score of similarity exceeds a threshold the system identifies the delayed message as suspicious or malicious. In such a case the delayed message may be deleted and may not be delivered to the user.

According to some embodiments the similarity algorithm includes generating a first signature from the incoming suspicious or malicious message, generating a second signature from the delayed message and comparing the first signature with the second signature to thereby derive the score of the similarity.

In some embodiments the method further comprises extracting a first property from the malicious or suspicious message and a second property from the delayed message. The first property or the second property includes of data, content, metadata of the message, a link embedded in the message, an attachment embedded in the message, a domain, an IP address, subject of the message and body of the message.

According to some embodiment the first signature is generated from the properties of the malicious or suspicious message and the second signature is generated from the properties of the delayed message. According to some embodiments the similarity algorithm comprising matching data having an at least one sequence of identical bytes.

According to some embodiments the suspicious or malicious message or the delayed message are messages that bypasses a filter for detecting malicious messages.

According to some embodiments the messages dealt with by the system are already delivered to the messaging inbox of the recipient.

According to some embodiments there is provided a non-transitory computer-readable medium comprising instructions which when executed by at least one processor causes the processor to perform the method of the present disclosure.

According to some embodiments there is provided a system and method for receiving a message designated to a plurality of recipients and delivering the message only to one or more selected recipients. The selected recipients are classified as having high level of awareness to malicious messages. The system further monitors the behavior of the selected recipient with the message. The monitoring results in identifying status of the message. If the status of the message is identified as malicious the system performs mitigation action on the message for disabling the message. Otherwise the system delivers the message to the other recipients.

### BRIEF DESCRIPTION OF THE DRAWINGS

In the drawings:

FIG. 1 schematically illustrates a system in which the present invention may be practiced, in accordance with one embodiment;

FIGS. 2A and 2B are exemplary screen layouts generally illustrating the implementation of a report button for suspicious email messages;

FIG. 3 is a flow chart illustrating a suspicious message handling process, according to an embodiment of the invention;

FIG. 4 is a flow chart illustrating an email inspection process, according to an embodiment of the invention;

FIG. 5 is a flowchart illustrating a first method for delaying message delivery to users with low level of awareness according to some embodiments of the invention;

FIG. 6 is a flowchart illustrating a scenario of delaying message delivery to users with low level of awareness, according to some embodiments of the invention;

FIG. 7 is a flowchart illustrating a second method for delaying message delivery to users with low level of awareness, according to some embodiments of the invention;

FIG. 8 is a flowchart illustrating a third method for delaying message delivery to users with low level of awareness, according to some embodiments of the invention; and

FIG. 9 is a flowchart illustrating a process for identifying suspicious messages, according to some embodiments of the invention.

### DETAILED DESCRIPTION OF THE INVENTION

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The following discussion is intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other computer systems and program modules.

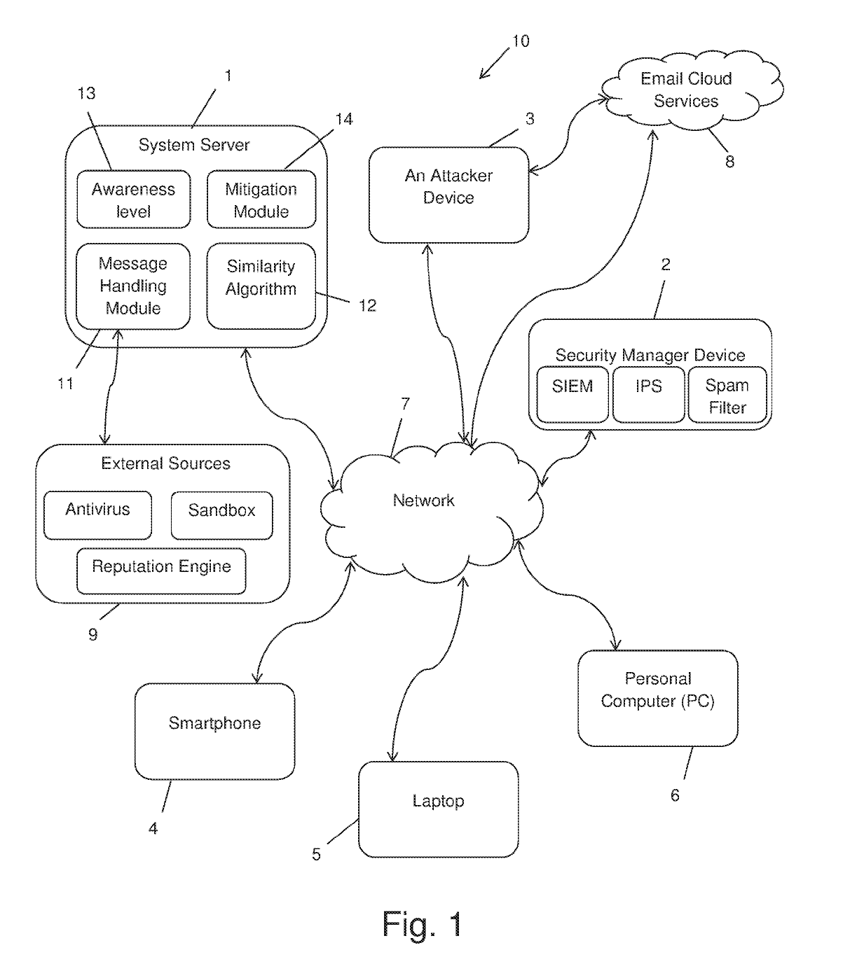

FIG. 1 schematically illustrates a system 10 in which the present disclosure may be practiced, in accordance with an embodiment. In system 10, network devices or network services such as those indicated by numerals 1, 2, 3 and 8 are communicatively coupled to computing devices 4, 5 and 6 via a network 7. The number of devices is exemplary in nature, and more or fewer number of devices or network services may be present.

A computing device may be one or more of a client, a desktop computer, a mobile computing device such as a Smartphone, tablet computer or laptop computer, and a dumb terminal interfaced to a cloud computing system. A network device may be one or more of a server (e.g., a system server as indicated by numeral 1), a device used by a network administrator (as indicated by numeral 2), a device used by an attacker (as indicated by numeral 3), a cloud service (e.g., an email cloud service as indicated by numeral 8), and external sources that can be used as a data source from which information about malicious messages and/or their content (file/URL) can be retrieved, such as antivirus, sandbox, reputation engines or other malicious detection tools or sources (as indicated by numeral 9). In general, there may be very few distinctions (if any) between a network device and a computing device. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

According to an embodiment of the invention, at least one individual user (e.g., of a computer device) is assigned with an awareness level that may represent the skills and/or abilities of the user to identify malicious attack attempts in an electronic messaging environment, for example the ability to identify possible phishing attacks. The awareness level for each user can be set automatically according to his success/failure rate to report targeted electronic messages based attacks in the past when they happened, manually by a system administrator or other authorized person, or a combination thereof. For example, the system administrator might apply a simulated attack program to determine the user awareness level. The awareness level might change over time based on the user performance in the simulated attack program and/or the day-to-day experience, or manually by a system administrator or other authorized person.

For example, if the user were reporting an email as suspicious and it turned out to be an actual targeted attack, based on other users reports or an expert report, the user awareness level will be leveled up. On the other hand, if a suspicious email was residing in the user mailbox and the user fails to report about it, and it finally turned out to be an actual malicious one or a simulated one as explained above, the user awareness level may remain the same or might be even reduced to a lower awareness level.

According to an embodiment, the communication between computer devices and system's server may be encrypted, e.g., with asymmetric keys, symmetric key, pre-shared or other encryption methods.

According to an embodiment, system server 1 may include the following modules: an email handling process module 11, a similarity algorithm module 12 and an awareness level module 13 for setting the awareness level of each mailbox user as will be described in further details hereinafter, a mitigation module 14 to be responsible for reacting to polymorphic attacks and integrating with cloud/on-premise security services and appliances like SIEM and EOP in order to mitigate phishing attacks on the network gateway/cloud level before reaching endpoint and or other server devices inside the company network, and for other mitigation decisions regarding suspicious messages, both automated decisions and preconfigured ones.

### Scoring Based Phishing Message Report

Awareness levels may be used in computing a likelihood that a message is a real phishing attack, to classify whether a message is a real phishing attack and further to control it (e.g., delete or disable this message). In one embodiment, an estimation of likelihood that a message is a real phishing attack (herein called an “awareness score” or “score” in short) is a calculation of the respective awareness levels of individual users who reported the message. For example, such calculation may consider the sum of the respective awareness levels of individual users who reported the message. In one embodiment, a determination as to whether to classify a message as a real phishing attack is based on comparing the score to a threshold value. For example, any message with a score that exceeds the threshold value is classified as a real phishing attack. In one embodiment, the threshold is an adjustable parameter, adjusted according to one or more of the number of false alarms and the number of missed detections.

Yet another parameter that may aid in the determination of a likelihood of a message as a real/suspicious phishing attack, is the result of an analysis (e.g., by scan) of the message properties (links/attachments/domains/IPs) by an external sources like antivirus/sandbox engines and or other reputation engines, for example, if the file attached to the message was found to be malicious by such external sources (e.g., one or more antivirus engine), the attack can be triggered immediately regardless the awareness score, other scan/reputation results (e.g. newly created domain) can be used as a parameter in the overall calculation of the message together with other user/scan reports/results.

Users at all awareness levels will be able to report suspicious messages. The system will collect their reports and score each message based on the reporting users' awareness level (and lack of reporting over time).

A message assigned with a score above a certain predefined threshold will be classified as malicious (e.g., a spear-phishing e-mail message) and will be controlled by the system (e.g., deleted/quarantined/disabled), according to security policies or administrator decisions. The thresholds, score per level, and control operations can be set at the system's server 1 via a dedicated user interface (herein “dashboard”), where the system administrator (or other authorized user) can choose to assign different policies for suspicious messages. For example, messages can be email messages that were reported as suspicious within an organization, or by different policies for suspicious email that were reported globally and were collected from different networks or other organizations (i.e., from third party or external sources).

According to an, the system's server 1 may support the following actions:
Handle reported messages;
Inspect incoming/existing messages;
Serve Configuration and Settings (Rules/Actions/Employee Data);
Check for message status change (if delayed, or suspended by rule for example).

### Traps

“Traps” refers herein to those users who proved great skills in spotting malicious messages (e.g., spear-phishing emails) during previous attacks, or have been appointed by a security manager or administrator as ones regardless to their current awareness level, for instance, it can be set that each user assigned with an “Expert” awareness level is defined as a trap.

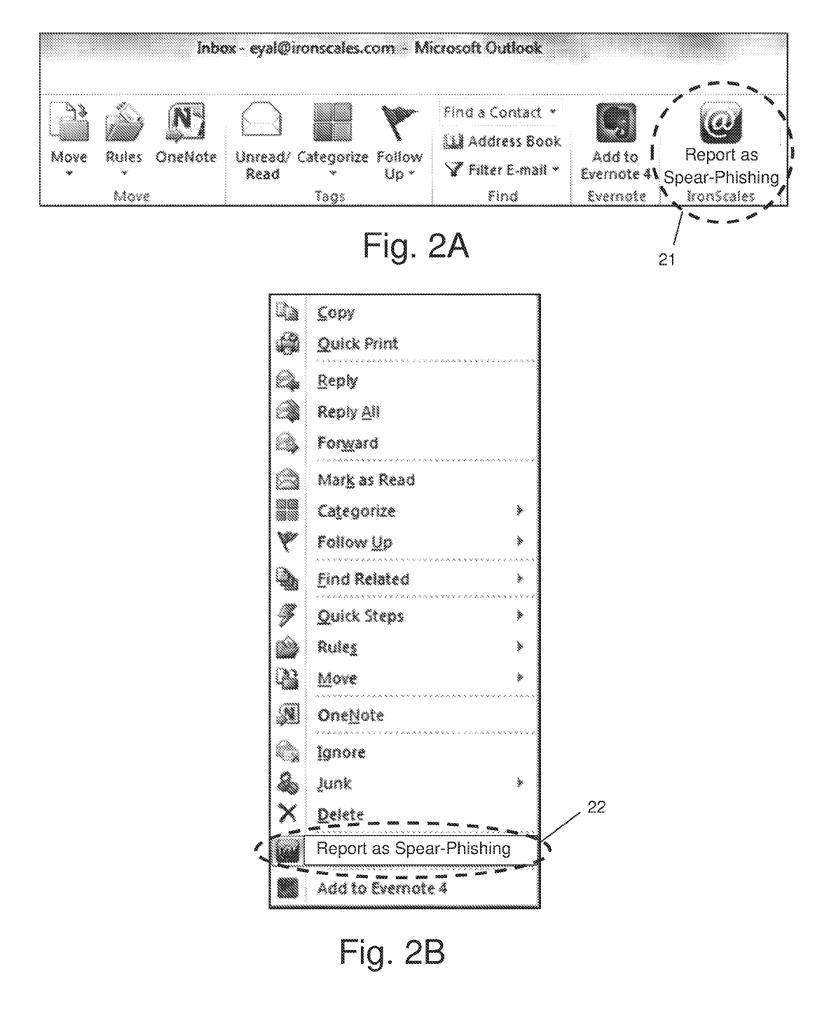

Traps may act as honeypots for malicious attacks, so that if an attacker has included such “trap” users in his attack target list, it is assumed that the attack will be intercepted and blocked by these users. Trap users may response quickly to an incoming malicious message (e.g., by activating a report action), so that their immediate response may lead eventually to the blockage or removal of the threat from other users who have received malicious message with similar properties. A trap user who is an employee at a specific organization or company may activate a report action on a suspicious email message, and accordingly similar email messages that have been received at other employees' mailboxes (of that organization or company) will be dealt with according that report action. For example, a report action can be implemented by variety of ways, such as in form of a clickable object provided inside the email or as an add-on to the email client (e.g., as indicated by numeral 21 in FIG. 2A and numeral 22 in FIG. 2B) or an email being forwarded to a predefined email address which being polled by the system (e.g., by link or attachment tracking as described hereinafter in further details), touch and swipe gestures, etc.

According to an embodiment, link tracking might be implemented by replacing the original link with dedicated link that will report back to the system and then redirect to the original link, or alternatively by collecting the information locally and send it to the system periodically or upon request.

Attachment tracking can be implemented by hooking the client system to track file operations like file open or file read or by registering to predefined client events or using any supported client API or by integrating any Rights Management System/Information Rights Management solution to put a code snippet/certificate inside the file which will report back to the system once the file was opened, previewed or read.

Moreover, While certain user inputs or gestures are described as being provided as data entry via a keyboard, or by clicking a computer mouse, optionally, user inputs can be provided using other techniques, such as by voice or otherwise.

Due to the fact that different employees with various awareness scores can receive a polymorphic message, and expectedly not all of them are capable of positively detecting a suspicious message, upon reporting a message suspicious, all of the messages in the organization's network with the same malicious content are detected and dealt with. The suspicious message reaction process (e.g., deletion/disable/quarantine/inline/alert/resolve by SOC/Traps) is performed by using a similarity algorithm, since messages might vary between users, e.g., different greetings or sender name, words replacements or subsections being replaced or added, the content of a message can be completely different but coming from the same SMTP server as the suspicious one, or having the same malicious file attached, etc., as well as and any other technique that can be used to bypass spam filters or any other automated analysis system.

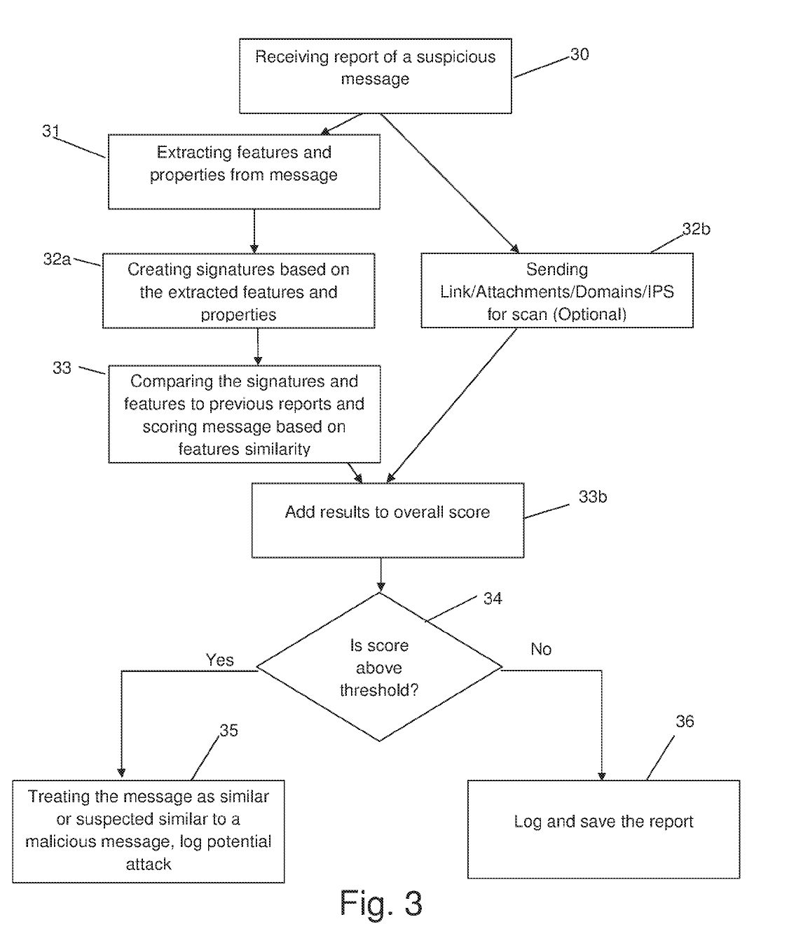

FIG. 3 is a flow chart illustrating a handling process for a suspicious message, according to an embodiment. The handling process involves the following steps: Receiving a message reported as suspicious (step 30);
Extracting from the reported message features and properties such as sender name and address, message headers, message subject, body, links—name and address, attachments type name, signatures and any other metadata that is extractable from the structure of the message, its content and metadata (step 31);
Creating signatures based on the above extracted features and properties (step 32a), for example, MD5/SHA1 and CTPH (computing Context Triggered Piecewise Hashes such as FuzzyHash), the signatures can be set on any subset of the message features, for example, the CTPH signature can be created using the message subject and body.
Comparing the signatures and features to previous reports (step 33), and scoring the message based on features similarity, for example, same sending name or address, same origin SMTP server or same SMTP servers path, same links name and addresses or same attachments filename or signature (Hash or FuzzyHash), or any other feature similarity that might indicate that the messages are basically the same message with some changes. Each feature has a predefined, configurable, score, that is added (step 33) to the overall score of the message.
Optional additional steps comprise scanning relevant properties (links/attachments/domains/IPs) using third party/external sources (step 32b), and adding the scan results to the message overall score (step 33b).
.
If the message's overall score is above a predefined threshold (step 34), the message is treated as suspicious (step 35). For example, if the FuzzyHash compare score is above a predefined threshold the messages will be treated as similar or suspected similar. Otherwise, the message it treated as a regular message, i.e. logged and saved (step 36).
   According to some embodiments a suspicious message is identified as malicious if the total score of suspiciousness of the message exceeds a threshold. The total score of suspiciousness of the message may be calculated by summing individual scores of users such that the affect of each individual score is derived from the awareness level of the user. That is to say: user with higher awareness level have more affect on the total score.
If the current report is similar to previous reports and the overall score is above the thresholds the email will be treated as malicious.

According to an embodiment, authorized persons such as a security manager/Traps users/Security Operation Center (SOC) Team are able to resolve pending issues using a resolution center, by receiving notification (e.g., an email with actionable links) or by using any other resolving mechanism provided.

Messages marked as malicious may or may not be deleted according to the predefined settings, for example, in case the message was marked as malicious, the security manager might decide to suspend/disable/put aside the alert, the security manager might also decide not to delete messages if not reported by any top level user (i.e., user assigned with a relatively high awareness level or as “trap”) although reached the threshold. For example, in that case the message will be set in pending status and will wait for high level/security manager/SOC team resolution, based on the configuration and settings.

Messages marked as pending resolution appear in a dedicated user interface (herein dashboard, SIEM or alike) or are sent to a predefined list of resolvers by email or any other means. The resolvers are able to investigate the message, decide whether it is a malicious or not, and report back to the system by using the dashboard or by clicking a link that appears in the message or by forwarding his resolve to a predefined address or by any other API the system may introduce or be integrated with.

According to an embodiment, the system writes and keeps logs for every event, e.g. new reports about suspicious messages, pending or deleted messages, etc., so it will be possible to collect and aggregate these logs with a Security Information and Event Management (SIEM) service/product, for real time alerts and analysis by an expert team (i.e., SOC).

### Skill Based Message Restrictions

According to an embodiment, the system allows an authorized user (e.g., security manager) to set restrictions/rules/operations on received messages for a specific user based on the awareness level of that specific user as proven in previous attacks or as set manually. For example, a security manager at a specific organization can set specific restrictions/rules/operations to an email account of an individual employee at that organization based on the awareness level of that employee.

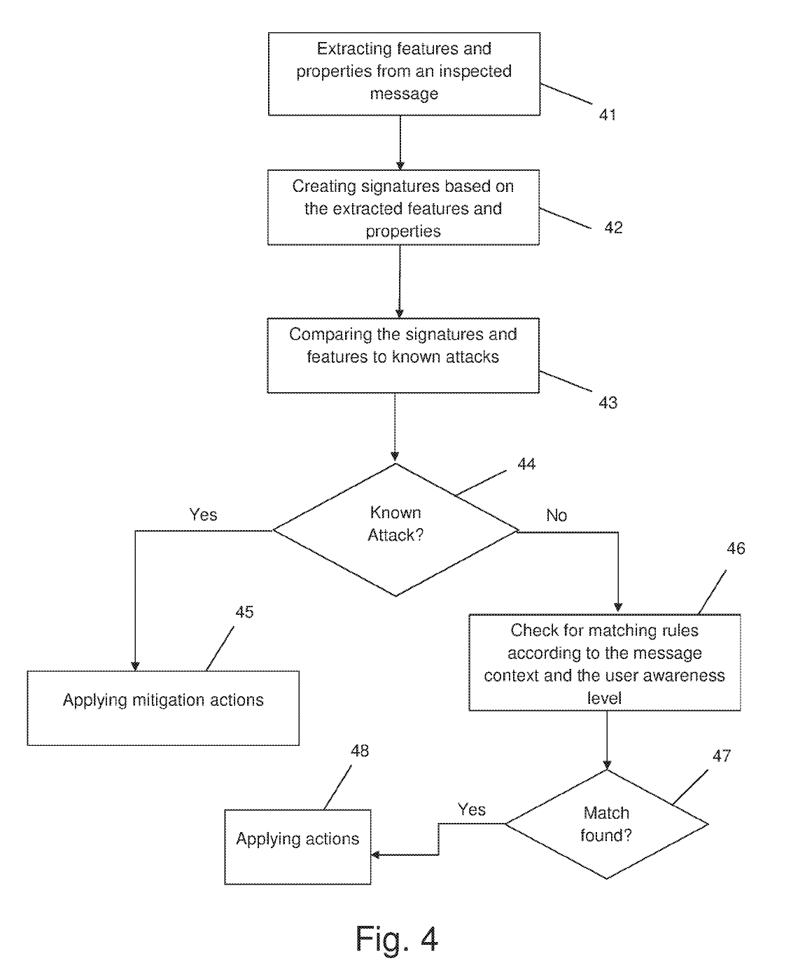

FIG. 4 is a flow chart illustrating a message inspection process, according to an embodiment. The inspection process may involve the following steps:
Extracting features and properties from an inspected message (step 41);
Creating signatures based on the extracted features and properties (step 42);
Comparing the extracted signatures and features to signatures of known attacks (step 43);
If the attack is known (step 44), applying mitigation actions (step 45);
If the attack is not known, checking for matching rules according to the message context and the user awareness level (step 46). If matched rules are found (step 47), applying relevant action (step 48).

For example, a security manager of a company may define what is allowed or forbidden by an employee of that company based on a received email message and the awareness level of that employee. In some embodiments, the security manager may define certain operations to be done upon each new email received or handled; such operation (e.g., the applied action in step 48) may include one or more of the following tasks:
deleting the message;
disabling links/attachments;
quarantining or moving the message to a different location;
queuing/delaying the message until investigated by higher skill rank;
adding message/alert/hints/guidance or other informative/hazard content into the message in any suitable form, such as textual, visual and/or audible forms (e.g., text, image, video file, audio file);
marking the message or its preview with flags or custom icons, colors or any other visual sign;
sending attachment/links for deeper/longer/manual scanning and analysis;
replacing links name with target address;
highlighting links target domains;
adding inline message with useful information about the message to aid decision (for example—sender address/domain); and/or
executing any other operation that might block a potential phishing/spear-phishing attack.

All the above will be better understood through the following illustrative and non-limitative rules examples:

User accounts of employees at a specific organization may be assigned with awareness level from one of the following rank categories: “easy clickers”, “newbies”, “novice” and “intermediate”, where “easy clickers” defines the lowest ranked users and “intermediate” defines the highest ranked users with respect to the awareness level. The restrictions for each category can be set as follows:
“Easy Clicker” or “Newby” employees are not allowed to receive emails with an attachment (specific extensions or all) from outside the organization network/untrusted or unknown source;
Emails with attachment from outside the organization network/untrusted or unknown source (i.e., first email ever from this sender/sending domain) addressed to “Easy Clicker” or “Newby” employees will be delivered in delay in order to ensure that a higher awareness level user will not marked it as suspicious/malicious and an alert text will be inlined;
“Novice” and “Intermediate” are not allowed to click on links leading to different address from what appears in the link name;
“Easy Clickers” to “Novice” will receive a specific guiding text inside emails with links/attachments to help them to handle the e-mail and validate its authenticity.
“Easy Clickers” will receive hints, as an inline text for example, about the real sender address, link names will be replaced with real target text (URL and Domain), and hints about suspicious mismatch between sender address and target links.

A schematic flow chart of an illustrative system operating in accordance with one embodiment, which employs a system's server and a client computer device flows, is shown in FIG. 1. The operation of this illustrative system is self-evident from the flow chart and this description and, therefore, is not further discussed for the sake of brevity.

The system manager or other authorized person will be able to set the rules and actions by using the user interface (dashboard) or by using any API given by the system.

The rules will define what is allowed or disallowed for users/employees based on their awareness level and the context of the message.

Every message, either new or existing, will be checked against the current set of rules and actions to decide on the proper action (step 46 in FIG. 4). The trigger to check an existing message can be activated by one or more of the following events:
the message being selected in the navigation pane;
the message is being previewed, read, or opened; or
any other trigger that might indicate that the message is being handled by the user.

In case the message context matches a rule set for the user awareness level, the action will be executed according to the configuration and settings (step 48 in FIG. 4).

### Incident Response Aiding

The system collects events such as clicks and opening of links and attachments in existing or received messages, so if an existing message will be set as malicious later on, for example, if reported by a high ranked user/Trap or by reaching the predefine threshold, the security manager will know who exactly took action on this malicious message and is now potentially infected with malicious Trojan/virus or any other malicious code.

The system's dashboard/API allows the security manager to receive this information for every active undergoing attack or past attacks, for example, if an email was reported and set as malicious by the system, the security manager will be able to extract a list of all employees that took action, e.g. clicked on a link that appears in the email or opened an attachment in the email, before and after the email was set as malicious, and act upon.

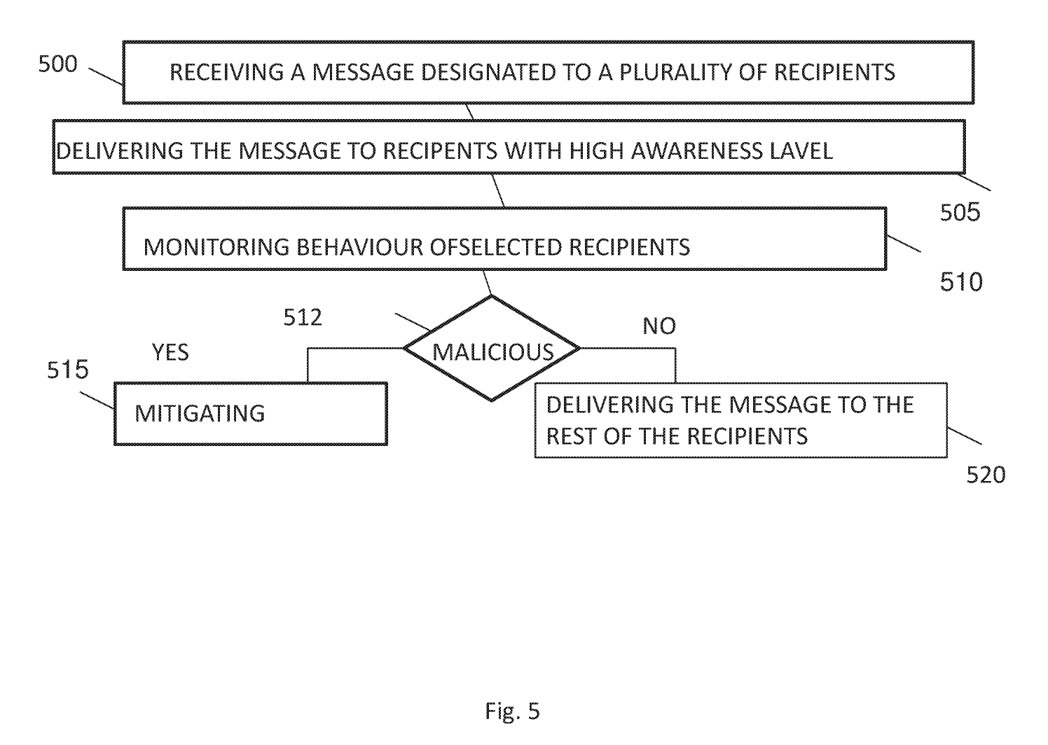

FIG. 5 is a flowchart of a first method for delaying message delivery to users with low level of awareness. According to some embodiments the system delays a delivery of a message to a user with low level of awareness until the message is verified and is identified as non malicious. Such a user may be for example a new employee, or a novice. If the message is identified as malicious it may not be delivered to the user. In some cases the delay is only for non trusted messages. A non trusted message may be, for example, a message from unknown source. In some embodiments a message that is sent to many recipients is first investigated by a recipient with high awareness level (selected recipients) and is delivered to the rest of the recipient after monitoring the behavior of the selected recipients with message and after verifying that the message is not malicious or suspicious.

Referring now to the drawings:

At block 500 a message designated to more than one recipient is received.

At block 505 the message is delivered only to one or more selected recipients. The selected recipients are typically recipients that are categorized as having high level of awareness. A user with high awareness level may be a user with intermediate experience for identifying malicious or suspicious messages, an advanced user or an expert. In some cases the message is delivered to professional staff for investigating the message. In some embodiments the recipients that are categorized with low level of awareness do not receive the message at this stage. The message may be stored, at least temporary, in a data repository. A recipient with low level of awareness may be, for example, Easy Clicker, new employee and a novice user.

At block 510 the system monitors behavior of the selected recipient and/or professional staff with the message. The monitoring may include monitoring operation with the message. Examples of such operations are deleting, forwarding reading replying interacting with the attachment and reporting the message as suspicious or malicious. The operation may also be sending a report about the status of the message or identifying the message as malicious or suspicious. The monitoring may be for a predefined period. The type of the message is identified as malicious or suspicious or as non malicious according to the results of the monitoring. According to some embodiments each operation is scored and when the total score exceeds a threshold the message is identified as malicious or suspicious. In some cases the monitoring is not performed by the system however, the system receives the results.

At block 512 the system checks the type of the message.

If the type of the message is identified as malicious or suspicious then at block 515 the system performs mitigation action on the message for disabling the message. In some embodiments the message is deleted and is not delivered to the other recipient. In some other embodiments a warning is sent to the other recipients. In some embodiments the message is disabled. In some embodiment the message is quarantined.

Otherwise (the message is not identified as malicious or suspicious) at block 520 the message is delivered to the other recipients. Such recipients are typically classified as having lower level of awareness comparing to the high level of awareness of the selected recipients.

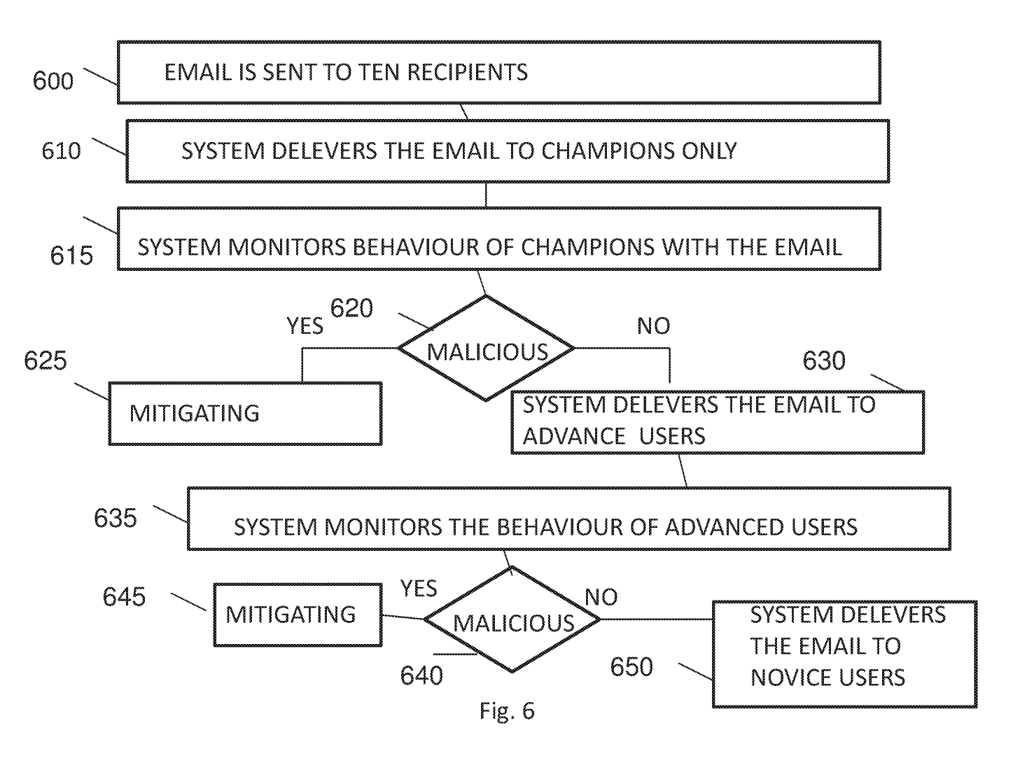

FIG. 6 is a flowchart of a scenario of delaying delivery of an email to users with low level of awareness.

At block 600 an email is sent to ten recipients at the same time. Two of the ten recipients are classified as users with high awareness level termed herein as champions, six of the ten recipients are classified as medium level of awareness termed herein as advanced and two are classified with low level of awareness termed herein as novice.

At block 610 the email is delivered to the champions only.

At block 615 the system monitors the behavior of the champions with regard to the message. Such a behavior may include reading, replying, deleting or reporting the message as suspicious or malicious.

At block 620 which may occur after a predefined period of monitoring, the system identifies maliciousness of the message. The identification is based on the monitoring.

If the message is identifies as suspicious or malicious then at block 625 the system performs mitigation action.

Blocks 630, 635, 640, 645 and 650 are performed if the message is not identified as malicious or suspicious by monitoring the behavior of the champions.

At block 630 the system delivers the message to the advanced users.

At block 635 the system monitors the behavior of the advanced users with regard to the message. Such a behavior may include reading, replying, deleting, reporting the message as suspicious or malicious.

At block 640 which occurs after monitoring the advance users, the system identifies based on the monitoring if the message is suspicious or malicious.

If the message is identifies as suspicious or malicious then at block 645 the system performs mitigation action such mitigation action may include deleting, warning

Otherwise at block 650 the system delivers the message to the novice users.

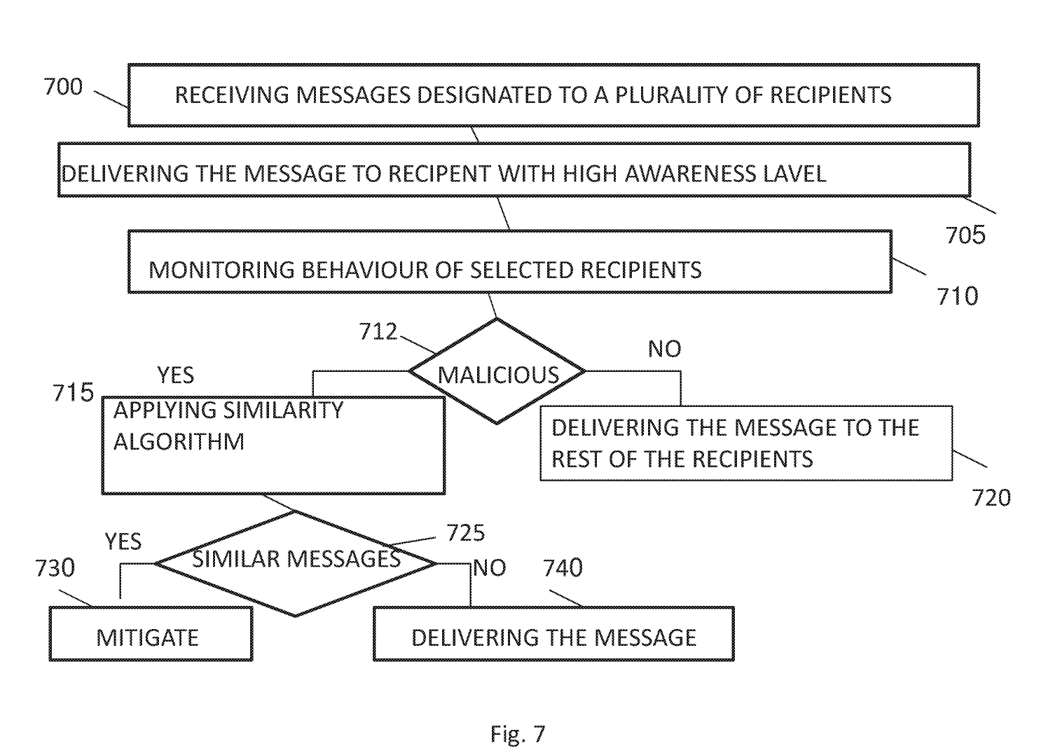

FIG. 7 is a flowchart of a second method for delaying message delivery to users with low level of awareness. According to some embodiments the system delays a delivery of a message to a user with low level of awareness until the message is verified and is identified as non malicious. If the message is identified as malicious it may not be delivered to the user. In some cases the delay is only for non trusted messages.

In some embodiments many similar or equal messages are sent to many recipients. In such a case only messages that are designated to recipients with high awareness level are delivered while the other messages are saved and are not delivered instantly. The system monitors the behavior of a recipient with the message and if the message is identifies as non malicious by the monitoring process all messages that are similar to this message are delivered to the recipients. If the message is identifies malicious by the monitoring process all messages that are similar to this message may be removed and may not be sent to the recipients.

Referring now to the drawings:

At block 700 a plurality of messages are received by a computing device that connects the internet cloud with a network of an organization. The pluralities of messages are designated to a plurality of recipients;

At block 705 the system selects a recipient that is classified as having high level of awareness to malicious messages and delivers only the message that are designated to the selected recipient. The other messages are stored in a data repository at least temporarily.

At block 710 the system monitors behavior of the selected recipient with the message. The behavior may include operations such as deleting the message, moving the message to a certain folder, forwarding the message to a certain recipient and sending a report. As a result of the monitoring the system identifies the type of the selected message. In some embodiments the monitoring is performed by another system and the system receives the results.

At block 712 the system checks the type of the message.

If the type of the selected message is identified as non malicious then at block 720 the message is delivered to the rest of the recipients.

Blocks 715, 725, 730 and 740 are performed if the selected message is identified as malicious. The Blocks are performed per each of the other message that has not been delivered yet.

At block 715 the system applies similarity algorithm for detecting similarity between the selected message and the other message. The system identifies a score of similarity

At block 725 the system checks the score of similarity between the selected message and the other message. If the score of similarity exceeds a threshold then at block 730 the system identifies the message as suspicious or malicious and may apply mitigation action on the message. Such mitigation action may include deleting warning disabling etc.

Otherwise at block 740 the system delivers the second message to a recipient of the message.

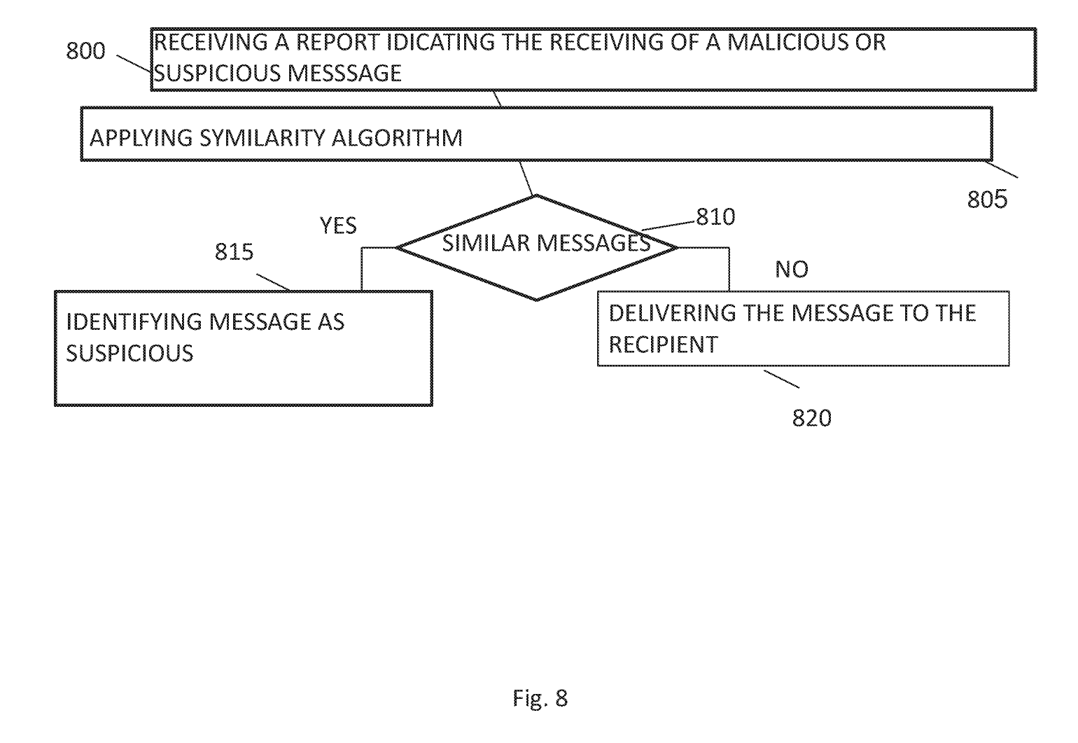

FIG. 8 is a flowchart of a process of identifying a suspicious or malicious message in accordance with some embodiments of the disclosed subject matter.

At block 800 the system receives a report indicating the receiving of a suspicious or malicious message. The report may be received from a computing device of a user that has received the message and has identified the message as suspicious or malicious. The report may be received from an expert.

At block 805 which occurs in response to or upon receiving the report, the system applies similarity algorithm for detecting similarity between the suspicious or malicious message and another message. In one embodiment other message is already received in the inbox of the recipient. In another embodiment the other message is not yet delivered to the recipient. In the latter a case the delivery is suspended until the similarity of the other message to the suspicions or malicious message is checked.

The result of the algorithm is a score of similarity.

At block 810 the system checks the score of similarity. If the score of similarity exceeds a threshold then at block 815 the other message is identified as suspicious or malicious and the system applies mitigation action (e.g. deletion, warning etc. For example if the message is already in the mailbox of the recipient it may be removed from the mailbox and a warning message may be sent to the recipient. If the message has not be delivered to the recipient of the server it may be removed from the server and may not be delivered to the recipient or may be delivered with a warning message.

Otherwise (the other message is not suspicious or malicious) at block 820 if the other message has not been delivered yet to the recipient the system delivers the message to the recipient.

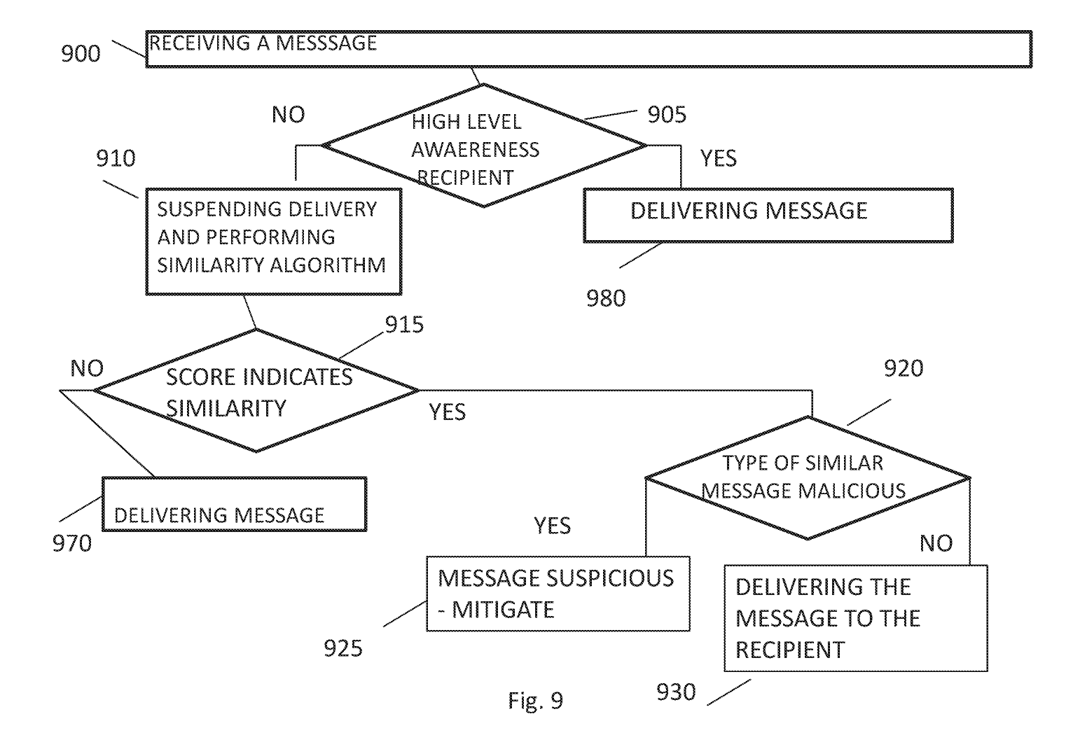

FIG. 9 is a flowchart diagram of a third method for suspending a message, in accordance with some embodiments of the disclosed subject matter.

At block 900 the system receives a message.

At block 905 the system checks if a recipient of the message is classified as having low level of awareness to suspicious or malicious messages.

If recipient is classified as having high level of awareness then at block 980 the message is delivered to the recipient.

Blocks 910, 915, 920, 925 930 and 970 are performed if the recipient is classified as having low level of awareness to suspicious or malicious messages.

At block 910 the system suspends the delivery the message to the recipient and performs similarity algorithm for detecting similarity between the suspended message and another (similar) message. In some embodiments the other message is designated to another recipient that is classified as having high level of awareness to suspicious or malicious messages. In some embodiments the other message is designated to the same recipient but has been or is planned to be forwarded to another recipient that is classified as having high level of awareness to suspicious or malicious messages.

At block 915 the system checks the score of similarity that results from the similarity algorithm. If the score of similarity indicates similarity between the two messages then operation proceeds to block 920. Otherwise at block 970 the system delivers the suspended message the recipient

At block 920 the system checks type of the other (similar) message. The type is derived or resulted from monitoring the behavior with the message of the other recipient. The monitoring may be performed by the system or by a third party. If the type of the message is malicious or suspicious then at block 925 the system identifies the suspended message as suspicious or malicious and may mitigate the suspended message. The mitigating may include deleting or quarantining or sending an alert message. Otherwise at block 930 the system delivers the suspended message the recipient.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that, in some alternative implementations, the functions noted in the block of a figure may occur out of the order noted in the figures. For example, two blocks shown in succession may, in fact, be executed substantially concurrently, or the blocks may sometimes be executed in the reverse order, depending upon the functionality involved.

Embodiments of the invention may be implemented as a computer process (method), a computing system, or as an article of manufacture, such as a computer program product or a non-transitory computer-readable media. The computer program product may be a computer storage media readable by a computer system and encoding a computer program of instructions for executing a computer process on the computer and network devices. The computer program product may also be a propagated signal on a carrier readable by a computing system and encoding a computer program of instructions for executing a computer process.

The functions described hereinabove may be performed by executable code and instructions stored in computer readable medium and running on one or more processor-based systems. However, state machines, and/or hardwired electronic circuits can also be utilized. Further, with respect to the example processes described hereinabove, not all the process states need to be reached, nor do the states have to be performed in the illustrated order. Further, certain process states that are illustrated as being serially performed can be performed in parallel.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components. The example screen layouts, appearance, and terminology as depicted and described herein, are intended to be illustrative and exemplary, and in no way limit the scope of the invention as claimed.

All the above description and examples have been given for the purpose of illustration and are not intended to limit the invention in any way. Many different methods of message analysis, electronic and logical modules and data sources can be employed, all without exceeding the scope of the invention.

1. A computer implemented method, the method comprises:
receiving a message wherein said message is designated to a plurality of recipients;
delivering said message only to a selected recipient from said plurality of recipients wherein said selected recipient is classified as having high level of awareness to malicious messages;
receiving a report indicating a type of said message; wherein said type being derived from a behavior of said selected recipient with said message; and
if said type of said message is malicious or suspicious performing mitigation action on said message for disabling said message;
otherwise delivering said message to an at least one other recipient from said plurality of recipients.

2. The method of claim 1 wherein said at least one other recipient is classified as a user with low level of awareness.

3. The method of claim 1, wherein said mitigating comprises one member selected from a group consisting of quarantining or deleting said message, or sending an alert message.

4. The method of claim 1, wherein said behavior comprises one member selected from a group consisting of reading, replying, interacting with attachment or link of said message, deleting or moving and reporting the message as suspicious or malicious.

5. A computer implemented method, the method comprises:
receiving a plurality of messages wherein said plurality of messages are designated to a plurality of recipients;
selecting a selected recipient from said plurality of recipients; wherein said selected recipient being classified as having high level of awareness to malicious messages;
selecting, from said plurality of messages, a selected message; wherein said selected message being designated to said selected recipient;
delivering said selected message only to said selected recipient;
receiving a report indicating a type of said message; wherein said type being derived from a behavior of said selected recipient with said selected message;
if said type of said selected message is identified as malicious or suspicious then
applying similarity algorithm for detecting similarity between said selected message and a second massage from said plurality of messages to, thereby, deriving a score of similarity; and if said score of similarity indicating similarity between said message and said second massage identifying said second message as suspicious or malicious and disabling said message.

6. The method of claim 5 wherein said disabling comprises deleting said message.

7. The method of claim 5, further comprising if said selected message is malicious or suspicious applying mitigation action on said selected message.

8. The method of claim 5, further comprising if said second message is malicious or suspicious applying mitigation action on said second message.

9. The method of claim 8, wherein said mitigating comprises one member selected from a group consisting of deleting said message, alerting and quarantining

10. The method of claim 5, wherein said behavior comprises one member selected from a group consisting of reading, replying, deleting and reporting the message as suspicious or malicious.

11. The method of claim 5, wherein said awareness level indicating the awareness of a recipient from said plurality of recipients for receiving a suspicious or a malicious message or the trustworthiness of said recipient.

12. The method of claim 5, wherein said behavior comprises one member selected from a group consisting of reading, replying, interacting with attachment of said message, deleting and reporting the message as suspicious or malicious.

13. A computer implemented method, said method comprises:
receiving a first message;
if a recipient of said first message is classified as having low level of awareness to suspicious or malicious messages then suspending the delivery of said first message to said recipient and performing similarity algorithm for detecting similarity between said message and a second message forwarded or designated to a second recipient; wherein said second recipient is classified as having high level of awareness to suspicious or malicious messages;
if score of similarity derived from said similarity algorithm indicating similarity between said first message and said second massage then if monitored behavior of said second recipient results in identifying said second message as malicious or suspicious then identifying said first message as suspicious or malicious,
if said score of similarity not indicating said similarity between said message and said second massage or if said monitored behavior of said second recipient with said second message not identifying said second message as malicious or suspicious delivering said first message to said recipient of said first message.
